(19) United States
(12) Patent Application Publication
(10) Pub. No.: US 2007/0054223 A1
(43) Pub. Date: Mar. 8, 2007

(54) Method for preparing photochromic film or plate

(76) Inventors: Tae-Sik Kang, Daejeon (KR); Se-Hui Han, Seoul (KR); Young-Jun Hong, Daejeon (KR)

Correspondence Address: MCKENNA LONG & ALDRIDGE LLP, 1900 K STREET, NW, WASHINGTON, DC, 20006, US

(21) Appl. No.: 11/515,931

(22) Filed: Sep. 6, 2006

(30) Foreign Application Priority Data
Sep. 6, 2005 (KR) 10-2005-0082747

(51) Int. Cl. G03C 1/00

(52) U.S. Cl. 430/345

(57) ABSTRACT

The present invention relates to a method of preparing a photochromic film or plate comprising forming an embossed portion on a part or the whole of a basic material to be coated, coating a photochromic substance on a part or the whole of the basic material on which the embossed portion is formed and forming a protective layer on the basic material on which the photochromic substance is coated, so as to protect the photochromic substance. According to the present invention, the photochromic substance is filled in each of unit embossed portions so that the photochromic substances filled in each of the unit embossed portions are isolated from each other, thereby prolonging the life of the photochromic substance.

This application claims the benefit of the filing date of Korean Patent Application No. 10-2005-0082747 filed on Sep. 06, 2005 in the Korean Intellectual Property Office, the disclosure of which is incorporated herein in its entirety by reference.

### TECHNICAL FIELD

The present invention relates to a method for preparing a photochromic film or plate, and more particularly, to a method for preparing a photochromic film or plate, in which a coating process is performed by filling a unit embossed portion with a photochromic substance and then forming a protective layer on a basic material on which the photochromic substance is coated so that the photochromic substances filled in each of the unit embossed portions are isolated from each other, thereby prolonging the life of the photochromic substance.

### BACKGROUND

Photochromic substances have been widely used in basic materials such as glass, plastic and the like to fabricate spectacle lenses, optical lenses, sunglasses, sun caps, ski goggles, toys, mirrors, glasses, films, building exterior materials, advertising materials, optical discs, etc.

Organic photochromic substances including a polymer matrix containing photochromic dyes are known through many theses and patents. In most of these substances, since the photochromic dyes are deteriorated and decomposed too fast by light, so that the average life span of the photochromic substance is not sufficient, there is a problem in that it is difficult to fabricate a product which is very useful for commercial purposes using the substances. As a result, there is a need for a stable organic photochromic substance.

In order to fabricate such a product, several methods have been proposed. For example, in order to endow a resultant polymer with a photochromic characteristic, there is a method in which the photochromic dye is incorporated into a polymerizable composition. However, there is also a problem that the photochromic dyes are sometimes damaged during a polymerizing process. To relieve the above problem, there are proposed some new solutions as described in US Patent Application Nos. 60/000,829, 60/001,677 and 60/011,429.

In European Patent No. A0195898 and US Patent No. 4,720,356 corresponding to the European Patent, the photochromic dye is incorporated in a composition of polymerizable matrix of hindered amine as a light stabilizer called HALS(hindered amine light stabilizer). And, in Korean Patent Publication No. 2000-0067988, a matrix for photochromic compounds is disclosed in which a functionalized hindered amine light stabilizer capable of reacting with an isocyanate group is linked to the polymer backbone by a covalent bond to form a grafted structure, thereby having an effect on the photochromic dye, in particular, spirooxazines.

Meanwhile, Korean Patent Publication No. 1995-0009349 describes an encapsulated photochromic composition which is fabricated by using addition agent, oil and gelatin in a spyro-based photochromic substance in order to increase the stability of the photochromic substance. Further, Korean Patent Publication No. 2000-0024335 describes a method of prolonging the photochromic characteristic and heat stability by fabricating a core-shell type nano-capsule, as shown in FIG. 1, having a structure in which a diarylethene-based photochromic compound is surrounded by a high polymer.

Recently, in Korean Patent Publication No. 2004-0073217, there is disclosed an automotive windshield in which a photochromic solution is filled between two glass-substrates and the color of which can be changed by ultraviolet rays, as shown in FIG. 2.

However, although the method of capsulating the photochromic substance provides an improved tolerance for the deterioration of the photochromic dye, there is also a problem in that it is difficult to commercialize the products due to the question of mass production and the increase in fabricating cost. Further, although the method of filling the photochromic substance between the two glass-substrates provides an extended life span of the product, when the ultraviolet rays are irradiated, the photochromic substance may be decomposed or deteriorated by permeating moisture or air from the outside; or by a very small amount of residual moisture, air, and impurities therein; and then since the decomposed radical substance further decomposes the adjacent photochromic substance, there is another problem that the life span of the product is sharply reduced.

### DISCLOSURE

[Technical Problem]

To solve the above-mentioned problems, an object of the present invention is to provide a method for preparing a photochromic film or plate, in which an embossed portion is formed on a basic material to be coated, and a photochromic substance is filled in the embossed portion, so that the photochromic substance filled in an embossed portion is isolated, thereby prolonging the life of the photochromic substance.

Furthermore, another object of the present invention is to provide a photochromic film or plate fabricated by the above method.

[Technical Solution]

In order to achieve the above objects, the present invention provides a method of preparing a photochromic film or plate, comprising forming an embossed portion on a part or the whole of a basic material to be coated; coating the embossed portion with a photochromic substance; and forming a protective layer on the basic material on which the photochromic substance is coated.

In addition, the present invention provides a photochromic film or plate fabricated by the above-mentioned method.

[Advantageous Effects]

According to the present invention, the method of fabricating the photochromic film or plate can provide a photochromic film or plate in which the life span of the photochromic substance is increased and thus the durability is remarkably improved.

### DESCRIPTION OF DRAWINGS

The above and other objects, features and advantages of the present invention will become more apparent from the following description of preferred embodiments given in conjunction with the accompanying drawings, in which:

FIG. 1 is a photograph taken by observing a core-shell type nano capsule with TEM;

FIG. 2 is a cross-sectional view showing a conventional photochromic glass;

FIG. 3 is a cross-sectional view showing an example of the structure of a photochromic film or plate according to the present invention;

FIG. 4 is a cross-sectional view showing various shapes of the embossed portion according to the present invention;

FIG. 5 is a cross-sectional view showing another example of the structure of a photochromic film or plate according to the present invention; and

FIG. 6 is a cross-sectional view showing yet another example of the structure of a photochromic film or plate according to the present invention.

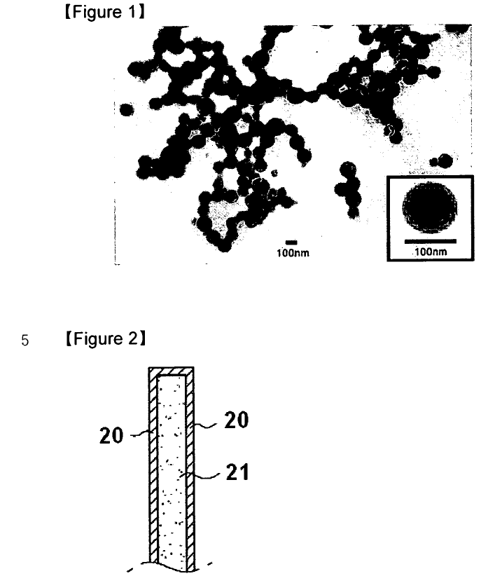

<Explanation of Reference Numerals for Designating Main Components in the Drawings>

| | |
|---|---|
| 20: glass | 21: photochromic solution |
| 31, 51: basic material to be coated | 33: photochromic substance |
| 32: embossed portion | 61, 62: thin film for |
| 34, 53, 63: protective layer or protective film | preventing gas and moisture |
| 52: adhesive | |

### BEST MODE

Hereinafter, the embodiments of the present invention will be described in detail with reference to the accompanying drawings.

In a method for preparing a photochromic film or plate according to the present invention, an embossed portion is formed on a part or the whole of a basic material to be coated, and a photochromic substance is coated on the embossed portion, and then a protective layer is formed on the basic material on which the photochromic substance is coated so that the photochromic substances filled in each of the embossed portions are isolated from each other.

Process of Forming Embossed Portion on Basic Material to be Coated

In this process, the embossed portion is formed on a part or the whole of a basic material to be coated.

The basic material to be coated by a photochromic substance can be formed of glass, various plastic materials, an inorganic film, an organic film or a material on which an organic/inorganic hybrid film is coated, ceramic, metal, a fiber, paper and the like.

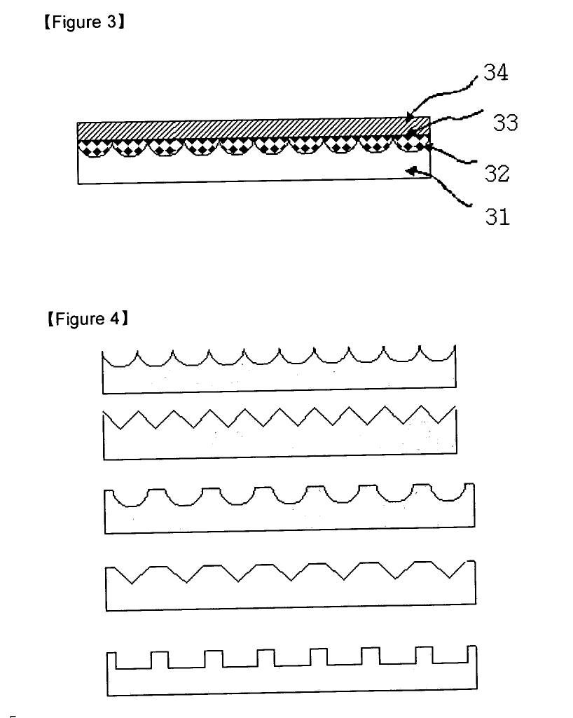

FIG. 3 shows an example of the structure of a photochromic film or plate fabricated by a method of preparing a photochromic film or plate according to the present invention.

In the process of forming the embossed portion on the basic material to be coated, a mold having an embossed surface is put on the basic material to be coated, and pressure is then applied to the mold so as to copy an embossed shape on the basic material. If necessary, heat may be also applied. When continuously performing the copying process, a roll-to-roll method may be used.

Plasma may be used in another method of forming the embossed portion on a surface of the basic material to be coated. The plasma may be non-equilibrium plasma generated by AC (e.g., radio frequency, microwave) or DC. As known in the art, the plasma process can be performed at either atmospheric pressure or sub-atmospheric pressure. In the case of using a reactive ion, it is referred to as ‘reactive ion etching’ (RIE). In order to generate a reactive radical ion in the form of plasma, oxygen, nitrogen, argon, air, FH, BCl₃, Cl₂ or a mixed gas thereof may be used. However, the gas is not limited to these and may be properly selected according to the material of a film to be etched.

The embossed portion formed on the surface of the basic material to be coated may be formed by another method such as a chemical etching method. Examples of chemical etching methods are HF-based etching, sulfuric acid and hydrogen peroxide-based etching, hydrochloric acid and hydrogen peroxide-based etching, piranha etching, NaOH or KOH-based etching, nitrohydrochloric acid-based etching and the like. The chemicals are not limited to these and may be properly selected according to the ingredients of the basic material to be coated.

As shown in FIG. 4, the embossed portion 32 may be in various forms such as a semicircle, a triangle, a quadrangle and the like, but is not limited to these.

The diameter and depth of the formed embossed portion 32 may be adjusted according to its use and shape, preferably to an extent of 5 nm to 1 mm. In the case that the diameter and depth of the embossed portion 32 are less than 5 nm, since the size of the embossed portion 32 is too small and a very small amount of the photochromic substance is filled therein, there is a disadvantage in that an optical density is lowered and thus its practical utility is also lowered. In the case that the diameter and depth of the embossed portion 32 are more than 1 mm, since an excessive amount of the photochromic substance is filled in the embossed portion 32, there is another disadvantage in that a large quantity of the photochromic substance is consumed. Further, in the case that some of unit embossed portions are defective or the photochromic substances in the unit embossed portions are deteriorated, since such a defect is clearly visible, there is yet another disadvantage that its practical utility is lowered.

The photochromic substance may contain a thermosetting or photo-curable monomer, oligomer and an initiator. Further, the photochromic substance is used in the state of being dissolved in a solvent together with a high polymer or being dissolved alone in a proper solvent.

Process of Coating Photochromic Substance on Embossed Portion

In this process, the photochromic substance is coated on a part or the whole of the basic material on which the embossed portion is formed.

The process of coating the photochromic substance on the basic material on which the embossed portion is formed further comprises, before and/or after a coating process of the photochromic substance, a process of additionally coating an inorganic film, an organic film, an inorganic/organic hybrid coating film or a multilayered film thereof in order to lower gas or moisture permeability.

The inorganic film may be formed of metal thin films, metal oxides, metal nitrides, metal fluorides and the like, and the organic film may be formed of polyethylene, polypropylene, polyethylene terephthalate, polyimide, an organic matter containing fluorine, a matter containing carbon and the like.

As known in the art, bar coating, dip coating, flow coating, spray coating, inkjet coating, slit coating, roll coating and the like can be used as the method of coating the photochromic substance. It is also possible to perform a single-sided coating as well as a double-sided coating.

The process of coating the photochromic substance on the embossed portion may further comprise a process of raking out the photochromic coating solution on a top portion of the embossed portion by using a knife.

Process of Forming Protective Layer

In this process, a protective layer is formed to protect the photochromic substance coated on the basic material on which the embossed portion is formed.

The protective layer may be formed of glass, various plastic materials, an inorganic film, an organic film or a material on which an organic/inorganic hybrid film is coated, ceramic, metal, a fiber, paper and the like.

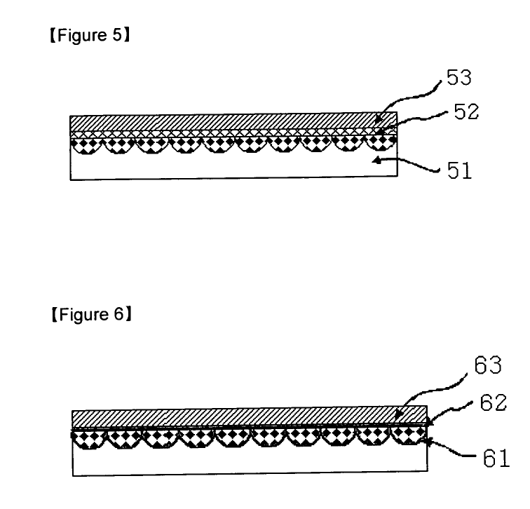

The protective layer may be formed by the method of FIG. 3 in which a coating solution is directly coated and then cured to form the protective layer 34, the method of FIG. 5 in which a protective film 53 is additionally attached by using an adhesive 52, or the method of FIG. 6 in which a material having a lower moisture permeability is additionally deposited or coated as thin films 61 and 62 before and/or after coating the photochromic substance on the basic material on which the embossed portion is formed and the like.

In addition, the protective layer may be also formed by a functional coating method such as an antifogging coating, a low reflection coating, a antifouling coating and so on.

The coating solution may be a thermosetting or UV cured coating solution including an acrylic hard coating paint or a silicon-based hard coating paint and the like.

The methods of curing the coating solution comprise UV curing, EB (electron beam) curing, thermosetting or natural dry curing.

The protective layer may comprise a further layer coated by the functional coating method.

The photochromic film or plate fabricated by the above-mentioned method is characterized in that the photochromic substances are coated in an independent embossed unit of 5 nm to 1 mm and then isolated from each other.

The photochromic film or plate can be used for fabricating of spectacle lenses, optical lenses, sunglasses, sun caps, ski goggles, toys, mirrors, glasses, films, building exterior materials, advertising materials, optical discs, etc.

### First Embodiment

An embossed portion is formed on a basic material of PET film by using a mold having semicircular protrusions each of which is respectively 10 μm in diameter and height. A thermosetting photochromic coating solution (e.g., UT11PC fabricated by LG chemical LTD) is coated on the basic material on which the embossed portion is formed, and a part of the photochromic coating solution on the basic material is raked out by a knife so that the photochromic coating solution remains only in the embossed portion, and then the photochromic coating solution in the embossed portion is cured. Using an adhesive, a PET film is attached as a protective layer to the surface of the basic material on which the photochromic coating solution is coated.

Durability of the photochromic film fabricated by the above-mentioned method was measured by using a quick UV tester (Atlas UV12000). On the basis of the light transmittance when the photochromic film is colored just before testing, a time (t_{1/2}), when the level of the coloring of the photochromic film is reduced to 50% of an initial value, durability was measured and isindicated in table 1.

### Second Embodiment

The method of fabricating the photochromic film in the second embodiment is similar to that in the first embodiment except that, when forming the protective layer, a photo-curable hard coating solution (AU1104GN fabricated by LG chemical LTD) is coated and then cured. Then, the durability of the photochromic film was also measured by the method as described in the first embodiment.

### Third Embodiment

The method of fabricating the photochromic film in the third embodiment is similar to that in the first embodiment except that the embossed portion is formed on the basic material of PET film by using a mold having pyramidal protrusions of which the length of each side of the base is 10 μm and the height is 15 μm. Then, the durability of the photochromic film was also measured by the method as described in the first embodiment.

### Fourth Embodiment

The method of fabricating the photochromic film in the fourth embodiment is similar to that in the first embodiment except that the embossed portion is formed on a basic material of PC film by using a mold having semicircular protrusions each of which is respectively 10 μm in diameter and height. Then, the durability of the photochromic film was also measured by the method as described in the first embodiment.

### Fifth Embodiment

The method of fabricating the photochromic plate in the fifth embodiment is similar to that in the first embodiment except that the embossed portion is formed on a glass plate having a thickness of 2 mm as the basic material by etching with HF and a glass plate having a thickness of 2 mm is attached as the protective layer by an adhesive to a surface of the basic material on which the photochromic coating solution is coated. Then, the durability of the photochromic plate was also measured by the method as described in the first embodiment.

### Sixth Embodiment

The method of fabricating the photochromic film in the sixth embodiment is similar to that in the first embodiment except that, before coating the photochromic coating solution, SiO₂ is coated on the basic material, on which the embossed portion is formed, at a thickness of 20 nm by a sputtering method, and after coating the photochromic coating solution, SiO_{2 is} coated again at a thickness of 20 nm by sputtering. Then, the durability of the photochromic film was also measured by the method as described in the first embodiment.

### COMPARATIVE EXAMPLE 1

A method of fabricating the photochromic film in the example is similar to that in the first embodiment except that the embossed portion is not formed on the basic material of PET film and the basic material is coated by a continuous thin film. Then, the durability of the photochromic film was also measured by the method as described in the first embodiment.

TABLE 1

| | First | Second | Third | Fourth | Fifth | Sixth | |
|---|---|---|---|---|---|---|---|
| | embodiment | embodiment | embodiment | embodiment | embodiment | embodiment | Example 1 |
| Durability | 760 | 610 | 730 | 710 | 1250 | 870 | 310 |
| (t_{1/2}, hours) | | | | | | | |

As indicated in table 1, in the comparative example 1, since the embossed portion is not formed on the basic material and thus the photochromic layer is coated continuously, if a part of the photochromic layer is inactivated by moisture or oxygen, the inactivated area exerts an influence over adjacent areas and thus the whole area of the photochromic layer is inactivated. Therefore, the durability is remarkably lowered. However, in the first to sixth embodiments, since the embossed portion is formed on the basic material and then the photochromic substance is coated thereon so that the photochromic substances filled in each of the unit embossed portions are isolated from each other, the inactivated area scarcely exerts an influence over adjacent areas and thus the durability is improved twice or more. In addition, since the glass plate has a lower air or moisture permeability than the film, the glass plate has better durability. In the case that the SiO₂ thin film is coated before and after coating of the photochromic substance, the durability is further improved.

### INDUSTRIAL APPLICABILITY

As described above, the method of fabricating the photochromic film or plate according to the present invention can provide a photochromic film or plate in which the life span of the photochromic substance is increased and thus the durability is remarkably improved.

Those skilled in the art will appreciate that the concepts and specific embodiments disclosed in the foregoing description may be readily utilized as a basis for modifying or designing other embodiments for carrying out the same purposes of the present invention. Those skilled in the art will also appreciate that such equivalent embodiments do not depart from the spirit and scope of the present invention as set forth in the appended claims.

1. A method of preparing a photochromic film or plate, comprising:
forming an embossed portion on a part or the whole of a basic material to be coated;
coating a photochromic substance on a part or whole of the basic material on which the embossed portion is formed; and
forming a protective layer on the basic material on which the photochromic substance is coated.

2. The method according to claim 1, further comprising additionally coating an inorganic film, an organic film, an inorganic/organic hybrid coating film or a multilayered film thereof before and/or after the coating of the photochromic substance on a part or the whole of the basic material on which the embossed portion is formed.

3. The method according to claim 1, wherein the basic material is formed of glass, various plastic materials, an inorganic film, an organic film or a material on which an organic/inorganic hybrid film is coated, ceramic, metal, a fiber, or paper.

4. The method according to claim 1, wherein the embossed portion is formed by a copying method in which a mold having an embossed surface is put on the basic material to be coated, and pressure is then applied to the mold so as to copy an embossed shape on the basic material, a method in which plasma is applied at atmospheric pressure or sub-atmospheric pressure, a plasma reactive ion etching method or a chemical etching method.

5. The method according to claim 1, wherein the embossed portion has a diameter or a depth of 5 nm to 1 mm.

6. The method according to claim 1, wherein the method of coating the photochromic substance comprises bar coating, dip coating, flow coating, spray coating, inkjet coating, slit coating or roll coating.

7. The method according to claim 1, wherein the protective layer is formed of glass, various plastic materials, an inorganic film, an organic film or a material on which an organic/inorganic hybrid film is coated, ceramic, metal, a fiber, or paper.

8. The method according to claim 1, wherein the protective layer is formed by a method whereby a coating solution is directly coated and then cured on the basic material on which the photochromic substance is coated, a method whereby a protective film is additionally attached by using an adhesive, or a method whereby a material having a lower gas or moisture permeability is additionally deposited or coated in the form of a thin film.

9. The method according to claim 8, wherein the coating solution comprises an acrylic hard coating paint and a silicon-based hard coating paint.

10. The method according to claim 8, wherein the method of curing the coating solution comprises UV curing, EB (electron beam) curing, thermosetting or natural dry curing.

11. The method according to claim 1, wherein the protective layer further comprises a functional coating such as an antifogging coating, a low reflection coating, a antifouling coating and so on.

12. A photochromic film or plate fabricated by the method according to any one of claims 1 to 11, wherein a photochromic substance is independently filled in each of a number of unit embossed portions so as to be isolated from each other.

13. The photochromic film or plate according to claim 12, wherein the unit embossed portion in which the photochromic substance is filled has a diameter or a depth of 5 nm to 1 mm.

14. A use of the photochromic film or plate according to claim 12, for fabricating spectacle lenses, optical lenses, sunglasses, sun caps, ski goggles, toys, mirrors, glasses, films, building exterior materials, advertising materials, optical discs.
